(19) United States
(12) Patent Application Publication
(10) Pub. No.: US 2024/0045101 A1
(43) Pub. Date: Feb. 8, 2024

(54) Electronic Devices with Low-Reflectance Coatings

(71) Applicant: Apple Inc., Cupertino, CA (US)

(72) Inventors: Peter J Guest, San Jose, CA (US); Ivan S Maric, Palo Alto, CA (US); Cole Snider, San Diego, CA (US); Ming Kun Shi, Mogan Hill, CA (US); David Carnahan, Waltham, MA (US); Thomas T Morgan, Waltham, MA (US)

(21) Appl. No.: 17/746,879

(22) Filed: May 17, 2022

Related U.S. Application Data
(60) Provisional application No. 63/190,708, filed on May 19, 2021.

(51) Int. Cl. G02B 1/04; G02B 27/00; G06F 1/16; C09D 5/00; C09D 7/20; C09D 7/61; C09D 7/40; C09D 7/45; C09D 7/65

(52) U.S. Cl. CPC G02B 1/04; G02B 27/0093; G06F 1/163; G06F 1/1656; C09D 5/006; C09D 7/20; C09D 7/61; C09D 7/70; C09D 7/45; C09D 7/65

(57) ABSTRACT

An electronic device may include components that emit and detect infrared light. For example, a head-mounted device may have optical modules that present images to a user's left and right eyes. Each optical module may have an infrared light-emitting diode that emits infrared light that illuminates an eye box at an infrared wavelength, and an infrared camera that captures an image from the eye box at the infrared wavelength. A low-reflectance coating may be applied to one or more electronic device housing walls to prevent interference with the infrared components or with the visibility for a user. In particular, the low-reflectance coating may be a low-visible-reflectance-and-low-infrared-reflectance coating that exhibits low-reflectance across both visible and infrared wavelengths. The low-reflectance coating may be formed from carbon nanotubes and at least one organic solvent with zero polarity to ensure a low volatile organic component in the coating.

This application claims the benefit of provisional patent application No. 63/190,708, filed May 19, 2021, which is hereby incorporated by reference herein in its entirety.

### FIELD

This relates generally to electronic devices, and, more particularly, to electronic devices with low reflectance coatings.

### BACKGROUND

Electronic devices may have displays for displaying images. The displays may be housed in a housing. In some devices, such as head-mounted devices, displays may be housed in optical modules. If desired, electronic devices may include components that emit and detect light. These components may be operable at visible and/or infrared wavelengths. Because components capable of visible or infrared wavelength detection may be present in an electronic device, it may be desirable to coat portions of the electronic device housing in a low-reflectance coating. However, low-reflectance coatings typically include high levels of VOCs (volatile organic components) as solvents. It may be desirable to coat electronic devices with low-reflectance coatings having low levels of VOCs.

### SUMMARY

An electronic device may include components that are sensitive to infrared and/or visible light. For example, a head-mounted device may have optical modules that present images to the user's left and right eyes. Each optical module may have a lens barrel with a low-reflectance coating to suppress stray light, a display coupled to the lens barrel that generates a visible-light image, an infrared light-emitting diode that emits infrared light that illuminates the eye box, and an infrared camera that captures an image from the eye box at the infrared wavelength.

The low-reflectance coating may be a low-visible-reflectance-and-low-infrared-reflectance coating. In general, the low-reflectance coating may prevent interference with infrared and/or visible light components or users viewing visible light images. For example, in a head-mounted device, the low-reflectance coating may exhibit low reflectance for stray visible light from the display and for stray infrared light at the infrared wavelength from the light-emitting diode.

The low-reflectance coating may be formed from carbon nanotubes, such as multi-walled carbon nanotubes, a dispersant, water, and at least one organic solvent. The at least one organic solvent may have zero polarity, and the coating may have a low concentration of VOCs, while still providing low reflectance at visible and infrared wavelengths.

### BRIEF DESCRIPTION OF THE DRAWINGS

FIG. 1 is a top view of an illustrative head-mounted device in accordance with an embodiment.

FIG. 2 is a rear view of an illustrative head-mounted device in accordance with an embodiment.

FIG. 3 is a schematic diagram of an illustrative head-mounted device in accordance with an embodiment.

FIG. 4 is a cross-sectional side view of an illustrative head-mounted device optical module in accordance with an embodiment.

FIG. 5 is a cross-sectional side view of a step portion of an illustrative lens barrel in a head-mounted device optical module in accordance with an embodiment.

FIG. 6 is a cross-sectional side view of an illustrative low-reflectance coating on an electronic device housing in accordance with an embodiment.

FIG. 7 is an expanded view of a portion of an illustrative low-reflectance coating that includes carbon nanotubes in accordance with an embodiment.

FIG. 8 is a cross-sectional side view of an illustrative electronic device housing with multiple surfaces on which a low-reflectance coating may be applied in accordance with an embodiment.

FIG. 9 is a graph of an illustrative relationship between reflectance and wavelength for a low-reflectance coating in accordance with an embodiment.

### DETAILED DESCRIPTION

An electronic device such as a head-mounted device may have a front face that faces away from a user's head and may have an opposing rear face that faces the user's head. Optical modules on the rear face may be used to provide images to a user's eyes. Each optical module may have a lens barrel in which a lens is mounted. The lenses may be used to view displays that are mounted to the lens barrels. Components that emit and detect light may be mounted within the lens barrels. To suppress stray light reflections, the lens barrels may have low-reflectance coatings.

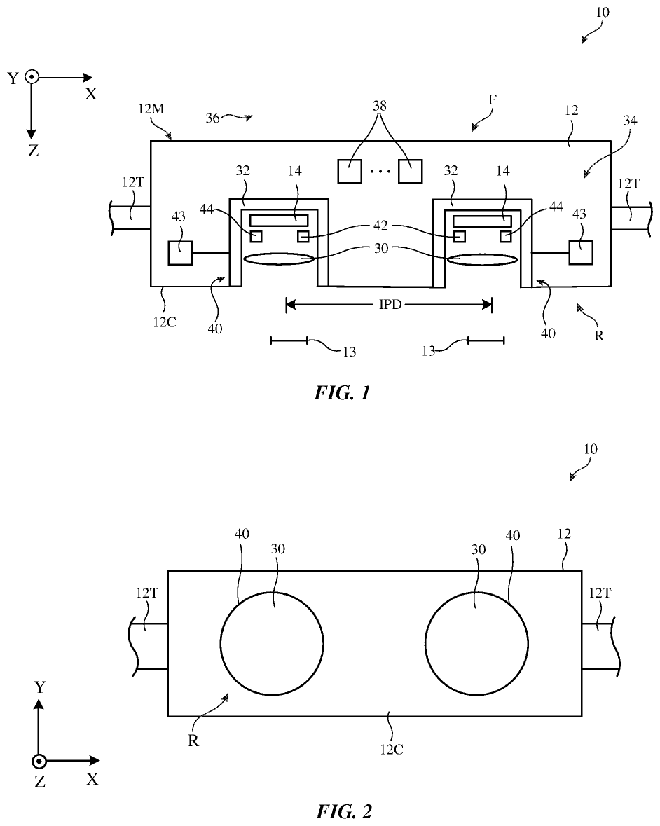

A top view of an illustrative head-mounted device is shown in FIG. 1. As shown in FIG. 1, head-mounted devices such as electronic device 10 may have head-mounted support structures such as housing 12. Housing 12 may include portions (e.g., support structures 12T) to allow device 10 to be worn on a user's head. Support structures 12T may be formed from fabric, polymer, metal, and/or other material. Support structures 12T may form a strap or other head-mounted support structures to help support device 10 on a user's head. A main support structure (e.g., main housing portion 12M) of housing 12 may support electronic components such as displays 14. Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures and these rigid walls may optionally be covered with electrical components, fabric, leather, or other soft materials, etc. The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, and/or other circuits and structures for device 10. Housing 12 may be configured to be worn on a head of a user and may form glasses, a hat, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have left and right optical modules 40. Optical modules 40 support electrical and optical components such as light-emitting components and lenses and may therefore sometimes be referred to as optical assemblies, optical systems, optical component support structures, lens and display support structures, electrical component support structures, or housing structures. Each optical module may include a respective display 14, lens 30, and support structure 32. Support structures 32, which may sometimes be referred to as lens barrels, lens support structures, optical component support structures, or optical module support structures, may include hollow cylindrical structures with open ends or other supporting structures to house displays 14 and lenses 30. Support structures 32 may, for example, include a left lens barrel that supports a left display 14 and left lens 30 and a right lens barrel that supports a right display 14 and right lens 30.

Displays 14 may include arrays of pixels or other display devices to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images.

Lenses 30 may include one or more lens elements for providing image light from displays 14 to respective eyes boxes 13. Lenses may be implemented using refractive glass lens elements, using mirror lens structures (catadioptric lenses), using Fresnel lenses, using holographic lenses, and/or other lens systems.

When a user's eyes are located in eye boxes 13, displays (display panels) 14 operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

It may be desirable to monitor the user's eyes while the user's eyes are located in eye boxes 13. For example, it may be desirable to use a camera to capture images of the user's irises (or other portions of the user's eyes) for user authentication. It may also be desirable to monitor the direction of the user's gaze. Gaze tracking information may be used as a form of user input and/or may be used to determine where, within an image, image content resolution should be locally enhanced in a foveated imaging system. To ensure that device 10 can capture satisfactory eye images while a user's eyes are located in eye boxes 13, each optical module 40 may be provided with a camera such as camera 42 and one or more light sources such as light-emitting diodes 44 (e.g., lasers, lamps, etc.). Cameras 42 and light-emitting diodes 44 may operate at any suitable wavelengths (visible, infrared, and/or ultraviolet). With an illustrative configuration, which may sometimes be described herein as an example, diodes 44 emit infrared light that is invisible (or nearly invisible) to the user. This allows eye monitoring operations to be performed continuously without interfering with the user's ability to view images on displays 14.

Not all users have the same interpupillary distance IPD. To provide device 10 with the ability to adjust the interpupillary spacing between modules 40 along lateral dimension X and thereby adjust the spacing IPD between eye boxes 13 to accommodate different user interpupillary distances, device 10 may be provided with actuators 43. Actuators 43 can be manually controlled and/or computer-controlled actuators (e.g., computer-controlled motors) for moving support structures 32 relative to each other. Information on the locations of the user's eyes may be gathered using, for example, cameras 42. The locations of eye boxes 13 can then be adjusted accordingly.

As shown in the rear view of device 10 of FIG. 2, cover 12C may cover rear face R while leaving lenses 30 of optical modules 40 uncovered (e.g., cover 12C may have openings that are aligned with and receive modules 40). As modules 40 are moved relative to each other along dimension X to accommodate different interpupillary distances for different users, modules 40 move relative to fixed housing structures such as the walls of main portion 12M and move relative to each other.

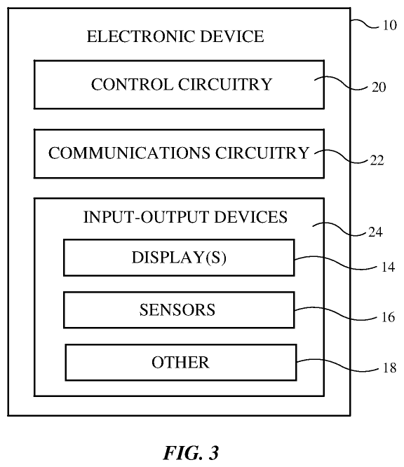

A schematic diagram of an illustrative electronic device such as a head-mounted device or other wearable device is shown in FIG. 3. Device 10 of FIG. 3 may be operated as a stand-alone device and/or the resources of device 10 may be used to communicate with external electronic equipment. As an example, communications circuitry in device 10 may be used to transmit user input information, sensor information, and/or other information to external electronic devices (e.g., wirelessly or via wired connections). Each of these external devices may include components of the type shown by device 10 of FIG. 3.

As shown in FIG. 3, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use display(s) 14 and other output devices in providing a user with visual output and other output.

To support communications between device 10 and external equipment, control circuitry 20 may communicate using communications circuitry 22. Circuitry 22 may include antennas, radio-frequency transceiver circuitry, and other wireless communications circuitry and/or wired communications circuitry. Circuitry 22, which may sometimes be referred to as control circuitry and/or control and communications circuitry, may support bidirectional wireless communications between device 10 and external equipment (e.g., a companion device such as a computer, cellular telephone, or other electronic device, an accessory such as a point device, computer stylus, or other input device, speakers or other output devices, etc.) over a wireless link. For example, circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs), and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input (e.g., voice commands), accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

Although electronic device 10 has been described as a head-mounted device, this is merely illustrative. In general, electronic device 10 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, a camera, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment. In the illustrative configuration of FIGS. 1 and 2, device 10 is a head-mounted device. Other configurations may be used for device 10 if desired. The example of FIGS. 1 and 2 is merely illustrative.

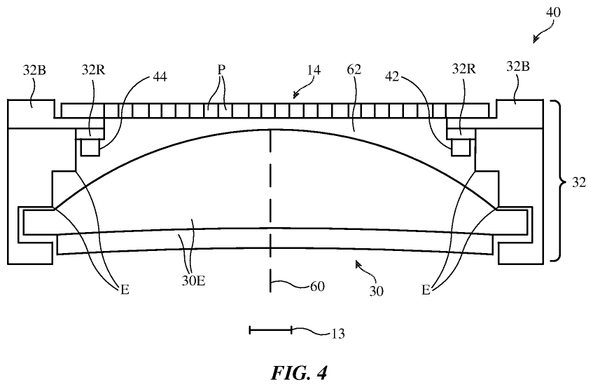

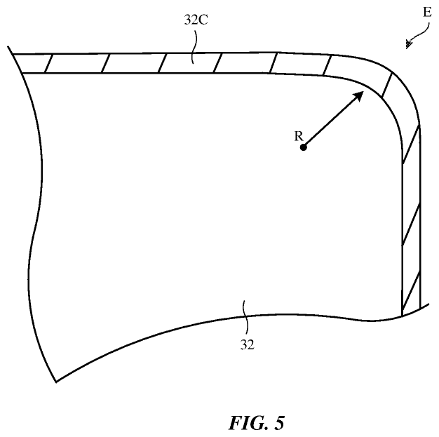

A cross-sectional side view of an illustrative optical module for head-mounted device is shown in FIG. 4. As shown in FIG. 4, optical module 40 may have support structures for display 14 and lens 30 such as lens barrel 32. During operation, lens 30 may be used to provide an image from pixels P of display 14 to eye box 13 along optical axis 60. When a user's eye is located in eye box 13, the user may view the image from display 14.

Lens 30 may be formed from one or more lens elements. In an illustrative configuration, which is sometimes described herein as an example, lens 30 is a catadioptric lens having front and rear lens elements 30E. Optical films 50 (e.g., linear polarizers, reflective polarizers, wave plates, partially reflective mirrors, antireflection coatings, and/or other optical layers) may be formed on one or more of the surfaces of the lens elements in lens 30. For example, one or more optical films and/or one or more adhesive layers for joining the lens elements and optical films together may be interposed between lens elements 30F and 30R. One or more optical films may also be formed on one or both of the exposed surfaces of lens 30. As an example, the surface of lens 30 that faces display 14 may be covered with a partially reflective mirror. The mating surfaces of lens elements 30E may have cylindrical curvature or may have other surface shapes (e.g., other curved shapes). The exterior surfaces of lens elements 30E may be spherical and/or aspherical. Lens elements 30E may be formed from glass, clear crystalline material such as sapphire, clear ceramic, and/or other transparent materials such as polymer. Transparent polymer may be shaped using molding techniques and/or machining techniques (e.g., using drills, milling machines, saws, polishing tools, laser-processing tools, grinding tools, and/or other tools for shaping and polishing lens 30).

During the operation of device 10, it may be desirable to gather information on the eyes of a user located in eye boxes 13. One or more cameras such as camera 42 of FIG. 4 and one or more light sources such as light-emitting diodes 44 may be located in interior region 60 of optical module 40 between lens 30 and display 14. Light-emitting diodes 44 may extend in a partial or full ring around the perimeter of display 14 (e.g., light-emitting diodes 44 may be mounted on a ring-shaped flexible circuit that extends in a rectangular ring shape, oval ring shape, and/or other ring shape surrounding optical axis 60). There may be one, at least two, at least four, at least six, fewer than 20, fewer than 10 or other suitable number of light-emitting diodes 44 (and/or other light sources such as lasers).

Light from light-emitting diodes 44 may illuminate the user's eyes in eye boxes such as eye box 13 of FIG. 4. The light provided by light-emitting diodes 44 may include visible light and/or infrared light. Camera 42 may be sensitive at corresponding wavelengths of light. In an illustrative configuration, one or more of light-emitting diodes 44 may emit light at a first wavelength (e.g., 850 nm, at least 740 nm, at least 830 nm, less than 900 nm, less than 1050 nm, and/or other suitable infrared wavelength) and one or more of light-emitting diodes 44 may emit light at a second wavelength that is longer than the first wavelength (e.g., 940 nm, at least 830 nm, at least 850 nm, at least 900 nm, less than 1000 nm, less than 1050 nm, at least 740 nm, and/or other suitable infrared wavelength). The light at the second wavelength may serve as gaze tracking illumination. The light at the first wavelength may illuminate the user's eyes during iris scanning operations (e.g., on start-up of device 10). Other types of infrared and/or visible light illumination may be provided by light-emitting diodes 44, if desired. The use of illumination at first and second wavelengths is illustrative.

The use of infrared light at the first wavelength in illuminating eye box 13 during iris scanning may help ensure that the eyes of the user are illuminated sufficiently to capture a clear iris image (eye image) during image capture operations with camera 42 (which is sensitive to light at the first wavelength). In an illustrative configuration, iris scan illumination is provided during initial start-up operations of device 10 (e.g., so that camera 42 can capture an eye image such as an iris scan or other biometric identification information). This allows device 10 to authenticate a user before the user is permitted to use device 10 and/or access information associated with the user's account. To ensure satisfactory contrast when capturing iris scans, the light at the first wavelength may be relatively close to the edge of the visible spectrum at 740 nm (e.g., 850 nm).

Some users may be able to faintly observe light at the first wavelength. Light at the second wavelength may be completely invisible to all users, allowing light at the second wavelength to be used continuously or nearly continuously for gaze tracking operations (e.g., after start-up operations). During gaze tracking operations, light-emitting diodes 44 may be used to provide gaze tracking illumination to eye boxes 13 while camera 42 captures eye images such as pupil images and/or eye images containing direct reflections of light-emitting diodes from the user's eyes (sometimes referred to as glints).

The support structures for optical module 40 may be formed from one or more supporting members. For example, one or more ring-shaped members may form the sides of lens barrel 32 surrounding lens 30. The support structures of module 40 (e.g., lens barrel 32) may, if desired, have a ring-shaped member that helps support display 14 (see, e.g., ring-shaped display bezel 32B, which may be attached to other portions of lens barrel 32 using adhesive, fasteners such as screws, welds, etc.). Electrical components such as camera(s) 42 and light-emitting diode(s) 44 may be supported using a ring-shaped cover. For example, cover ring 32R may have openings that receive respective electrical components. Light-emitting diodes 44 may, as an example, be mounted on a printed circuit substrate. Cover ring 32R may have through-hole openings arranged around some or all of the periphery of cover ring 32R. Each through-hole opening may receive a respective optical component (e.g., a respective light-emitting diode 44) and these optical components may be coupled to the cover ring using adhesive (e.g., adhesive with low-visible-light reflectance and sufficient infrared transmittance to allow emitted light from each light-emitting diode 44 to pass).

During operation of device 10, display 14 may emit stray visible light and/or stray visible light from display 14 may reflect from lens 30 (e.g., a partial mirror on the innermost surface of lens 30) onto the interior surfaces of lens barrel 32. Illumination from light-emitting diodes 44 may also potentially strike lens barrel 32 directly or after reflecting from lens 30. Stray visible light from display 14 can interfere with the user's ability to view images from display 14 satisfactorily. Stray eye illumination (e.g., stray infrared illumination from light-emitting diodes 44 at the first and/or second wavelengths) can interfere with the ability of camera 42 to capture satisfactory eye images (e.g., for biometric authentication and/or gaze tracking). To suppress undesired visible and infrared stray light in interior 62, the surfaces of lens barrel 32 in interior 62 may be provided with a low-reflectance coating (e.g., a coating with a reflectance of less than 1% or less than 2% from 380 nm to 1000 nm (as an example). The coating may be formed by anodizing lens barrel 32, electrodepositing light-absorbing material into anodization pores on lens barrel 32, and etching lens barrel 32 to create surface roughness on the pores and/or by otherwise treating the surface of lens barrel 32 to form a coating that exhibits low visible light reflection and low infrared light reflection. Any or all of the support structures in optical module 40 that are potentially exposed to stray visible and/or infrared light may be provided with the low-reflectance coating (e.g., display bezel 32R, light-emitting diode cover ring 32R, and/or other portions of lens barrel 32 may be provided with the low-reflectance coating). This may be accomplished by forming bezel 32R, ring 32R, and/or other portions of lens barrel 32 from aluminum members or other structures that may be provided with a low-visible-reflectance-and-low-infrared-reflectance coating (e.g., a low-reflectance anodized coating).

In the illustrative configuration of FIG. 4, lens barrel 32 has a cylindrical shape characterized by a longitudinal axis that is aligned with and/or parallel to optical axis 60. The walls of lens barrel 32 extend in a ring around axis 60 and may have one or more steps (sometimes referred to as shelf structures) characterized by step edges (shelf edges) E. Step edges E may be formed where the inner surfaces of lens barrel 32 that extend horizontally in FIG. 4 (with surface normals perpendicular to optical axis 60) meet with the inner surfaces of lens barrel 32 that extend vertically in FIG. 4 (with surface normals parallel to optical axis 60). Anodization operations tend to produce surface pores that extend parallel to the surface normal of the surface being anodized. There is therefore a risk that edges E will not be well covered by an anodized coating layer if edges E are sharp. As shown in FIG. 5, edges E may be provided with rounded (curved) cross-sectional profiles. As an example, each shelf edge E may be provided with a curved (rounded) cross-sectional shape of radius R, where the value of R is 0.5 mm, 0.3 to 2 mm, at least 0.1 mm, at least 0.25 mm, less than 3 mm, less than 1.5 mm, less than 0.8 mm, or other suitable value. The use of rounded edges E helps ensure that low-reflectance coating 32C will extend uniformly across edges E and thereby helps ensure that edges E will exhibit low reflectance.

The thickness of coating 32C may be 30 microns, at least 1 micron, at least 10 microns, at least 20 microns, at least 40 microns, at least 200 microns, less than 1000 microns, less than 300 microns, less than 120 microns, less than 75 microns, or less than 40 microns (as examples). Coating 32C may include black paint or ink (e.g., polymer containing black colorant such as pigment and/or dye), may include a carbon-nanotube-based coating, may include a black anodized layer, may include electroplated material, may include roughened surfaces formed by sand blasting, walnut blasting, chemical etching, machining (e.g., grinding, sanding, etc.), laser exposure, and/or other suitable surface roughening techniques. Low-reflectance material (e.g., chemically deposited layers, polymer layers including black colorant, etc.) may be deposited as part of an anodization process and/or may be applied separately. Multiple reflectivity reducing treatments may be applied to lens barrel 32, if desired.

In general, lens barrel 32 may be formed from any suitable unreflective structures (e.g., polymer or metal with black paint or other low-reflectance black polymer material such as polymer containing black pigment and/or black dye). If desired, barrel 32 or other coated structures may be formed from magnesium plated with aluminum, aluminum magnesium, aluminum zirconium, magnesium, plastic, steel, stainless steel, carbon fiber, composites, etc. If barrel 32 or other coated structures include magnesium, the magnesium may be conversion coated or finished (such as using micro-arc oxidation (MAO)) to protect against corrosion, if desired. The black paint or other low-reflectance black polymer material may then be applied over the coated/finished magnesium.

Although FIG. 5 shows coating 32C on lens barrel 32, this is merely illustrative.

Coating 32C may be formed on any desired surface of head-mounted device 10. Moreover, if electronic device 10 is another device, such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment, a coating may be formed on a housing of electronic device 10. In particular, electronic device 10 may have internal components in a housing that separates an interior of electronic device 10 from an exterior.

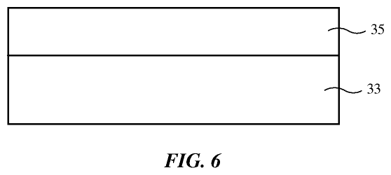

As shown in FIG. 6, coating 35, which may be a coating with the same properties as coating 32C, may be formed on housing wall 33. Electronic device 10 may have a front face, a rear face, and sidewalls that extend from the front face to the rear face. In some examples, a display may be viewable from the front face. Housing wall 33 may form the front face, rear face, and/or any of the side walls of electronic device 10. In some examples, coating 35 may be formed in a bezel region around a display within electronic device 10 (i.e., overlapping an inactive area of the display). In other examples, electronic device 10 may be a camera, and coating 35 may be formed on a housing portion of the camera or brackets for the camera. In this way, coating 35 may be formed on one or more housing walls of electronic device 10.

Although coating 35 is shown as being directly on housing wall 33, this is merely illustrative. If desired, an adhesion promotion layer and/or primer may be included between coating 35 and housing wall 33 to improve the adhesion of coating 35 to housing wall 33. In general, any desired layers may be included between coating 35 and housing wall 33.

Coating 35 (and coating 32C of FIG. 5) may be formed from multi-walled carbon nanotubes in a dispersant, water, and organic solvents. In particular, coating 35 may include two organic solvents, one of which has zero polarity. As a result, coating 35 may include a low volatile organic component (VOC). For example, coating 35 may have less than 700 g/L, less than 600 g/L, less than 500 g/L, or less than 250 g/L in VOC, as examples.

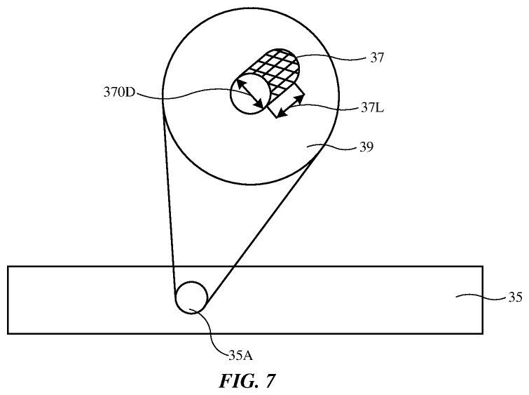

Moreover, coating 35 may have less than 1% reflectivity at visible wavelengths (380-760 nm) and less than 2% reflectivity at infrared wavelengths (760-1400 nm). However, these reflectivity values are merely illustrative. For example, coating 35 may have a reflectivity of 1.5% or less across visible wavelengths, a reflectivity of less than 2% across visible wavelengths, or any other desired reflectivity. Similarly, coating 35 may have a reflectivity of 1% or less across infrared wavelengths, a reflectivity of 1.5% or less across infrared wavelengths, or any other desired reflectivity. In this way, coating 35 may have low reflectivity in at both visible and infrared wavelengths, while having low VOC. An example of coating 35 is shown in FIG. 7.

As shown in FIG. 7, coating 35 may have portion 35A. A microscopic view of portion 35A shows carbon nanotube 37 having length 37L and outside diameter 370D. Carbon nanotubes 37 in coating 35 may have a purity of greater than 95%, greater than 90%, less than 99%, greater than 94%, or any desired purity. Length 37L may be between 5 microns and 30 microns, less than 30 microns, greater than 5 microns, or any other desired length. Outside diameter 370D may be between 10 nm and 20 nm, greater than 10 nm, less than 20 nm, or any other desired diameter. Carbon nanotubes 37 may be non-fuctionalized multi-walled carbon nanotubes, but may also be functionalized multi-walled carbon nanotubes, non-functionalized single-walled carbon nanotubes, or functionalized single-walled carbon nanotubes, if desired. In general, carbon nanotubes 37 may ensure that coating 35 has a low reflectivity, such as less than 1% reflectivity at visible wavelengths and less than 2% reflectivity at infrared wavelengths.

Carbon nanotubes 37, prior to curing coating 35, may be carried by solution 39, which may include dispersant, water, and at least one organic solvent. For example, the dispersant may be polyvinyl pyrrolidone (PVP), polyvinyl butyral (PVB), or any other desired dispersant. Coating 35 may include two organic solvents, one of which has zero polarity. Examples of organic solvents with zero polarity are hydrocarbons, such as pentane, hexane, and heptane. Other solvents may be used, however, such as cyclo-hexanone, amyl acetate, cyclo-pentane, or 4-methyl-2-pentanone. However, these solvents are merely illustrative. In general, any desired solvents may be used. By using at least one organic solvent with zero polarity, coating 35 may have a low VOC concentration.

Coating 35 may also include optical spacers, such as inorganic and/or organic particles, in solution 39, if desired. Optical spacers may further reduce the amount of VOC in coating 35. Reactive additives, such as isocyanate, carbodiimide, or any other desired additives may be added to coating 35, if desired. These reactive additives react with the water and/or dispersant in coating 35 to improve the strength of coating 35. Moreover, coating 35 may be applied to a substrate, such as substrate 33, at high temperatures (e.g., at temperatures of at least 100° C., at least 150° C., or other desired temperature) or may be preconditioned prior to application (e.g., stored at 50° C. for 1 day). However, these durability measures are merely illustrative. In general, coating 35 may be applied in any desired manner. These durability measures may allow for coatings with reflectivities of less than 3% across visible wavelengths, less than 3.5% across visible wavelengths, or any other desired reflectivity. Coatings applied with durability measures may have infrared reflectivities of less than 2% across visible wavelengths, less than 2.5% across visible wavelengths, less than 1.5% across wavelengths, or any other desired reflectivity. In this way, coating 35 may include various components to ensure low VOC concentrations and high strength when applied to surfaces, such as housing wall 33 of FIG. 6, while maintaining low reflectivity across visible and infrared wavelengths.

Coating 35 may be applied to a surface, such as housing wall 33 of FIG. 6 or lens barrel 32 of FIG. 5, with any desired thickness. For example, coating 35 may have a thickness of 30 microns or less, 25 microns or less, at least 10 microns, or any other desired thickness.

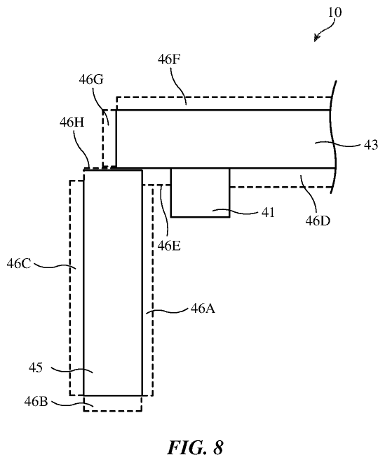

Examples of where coating 35 may be applied in an electronic device are shown in FIG. 8. As shown in FIG. 8, device 10 may include housing walls 43 and 45 (which may be similar or the same as housing wall 33 of FIG. 6). Component 41 may be formed on an interior surface of housing wall 43, if desired. Component 41 may be a camera, such as camera 42, a light source, such as light-emitting diodes 44, or any other component. For example, component 41 may be an ambient light sensor, a proximity sensor, an infrared sensor, an infrared light illuminator, or any other desired sensor.

As shown in FIG. 8, coating 35 may be formed on interior surface 46A of housing wall 45 and/or one or both portions of interior surfaces 46D/46E of housing wall 43. Alternatively or additionally, coating 35 may be formed on exterior surfaces 46B, 46C, and/or 46H of housing wall 45 and/or exterior surfaces 46F and/or 46G of housing wall 43. In this way, any desired housing wall surfaces, both interior and exterior to device 10, may be coated with coating 35, providing a low reflective coating in both the visible and infrared wavelengths.

Although FIGS. 5-8 have been described as including coating 32C and/or coating 35 on a housing wall of an electronic device, other coatings may also be applied, if desired. For example, additional ink(s) may be applied to the housing of a device, either in the same location as coating 32C/35 or in another location. These inks may include water-based paint with a low VOC, such as less than 500 g/L, less than 420 g/L, less than 400 g/L, or other desired VOC level. Alternatively or additionally, other coatings, such as oleophobic coatings, antireflection coatings, or any other desired coatings may be applied to portions of the electronic device housing.

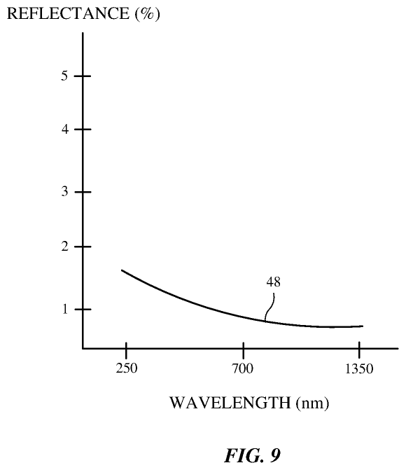

FIG. 9 is a graph showing the reflectance of an illustrative low-reflectance coating. The low-reflectance coating may be a coating such as coating 32C on lens barrel 32, coating 35 on one or more of housing walls 33, 43, and 45, or may be a low-reflectance coating formed on a surface of any other suitable electronic device support structure (e.g., an optical component support structure). FIG. 9 covers wavelengths such as visible light wavelengths and infrared light wavelengths. The visible light spectrum extends from 380 nm to 740 nm and includes representative visible light wavelengths such as 700 nm. The near infrared spectrum lies just beyond the 740 nm edge of the visible light spectrum and includes representative infrared wavelengths such as 1350 nm).

In the example of FIG. 9, coating 32C/35 exhibits a low visible light reflectance (e.g., the reflectance of coating 32C/35 across visible light wavelengths between 380 nm and 740 nm (or 400-700 nm, 400-740 nm, etc.) has a value R that is less than 1%, less than 1.5%, less than 2%, less than 0.5%, or less than 0.3% (as examples). Coating 32C/35 also exhibits a low infrared light reflectance (e.g., the reflectance of coating 32C/35 is less than 2%, less than 1.5%, less than 2.5%, less than 2%, or less than 1% at wavelengths of 760-1400 nm, at least 740 nm, at least 800 nm, 740-1000 nm, 850 nm, 900-950 nm, 940 nm, less than 1000 nm, etc.). Because coatings for lens barrel 32, such as coating 32C of FIG. 6, or coatings for a housing wall, such as coating 35 of FIGS. 7, exhibit low reflectance for both visible and infrared wavelengths, these coatings may sometimes be referred to as low-visible-reflectance-and-low-infrared-reflectance coatings.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A head-mounted device, comprising:
a support structure;
electrical components coupled to the support structure including a first component that emits light at a visible light wavelength and a second component that emits light at an infrared light wavelength; and
a low-visible-reflectance-and-low-infrared-reflectance coating on the support structure having less than 700 g/L in volatile organic content.

2. The head-mounted device defined in claim 1 wherein less than 1% of light at the visible wavelength is reflected by the low-visible-reflectance-and-low-infrared-reflectance coating and wherein less than 2% of light at the infrared light wavelength is reflected by the low-visible-reflectance-and-low-infrared-reflectance coating.

3. The head-mounted device defined in claim 2 wherein the low-visible-reflectance-and-low-infrared-reflectance coating comprises at least one organic solvent with zero polarity.

4. The head-mounted device defined in claim 3 wherein the at least one organic solvent is heptane.

5. The head-mounted device defined in claim 3 wherein the at least one organic solvent is selected from the group consisting of: pentane, cyclo-hexanone, amyl acetate, cyclo-pentane, and 4-methyl-2-pentanone.

6. The head-mounted device defined in claim 3 wherein the low-visible-reflectance-and-low-infrared-reflectance coating has a thickness of 30 microns or less.

7. The head-mounted device defined in claim 3 wherein the low-visible-reflectance-and-low-infrared-reflectance coating comprises multi-walled carbon nanotubes.

8. The head-mounted device defined in claim 7 wherein the multi-walled carbon nanotubes have a purity of at least 95%, an outside diameter of 10-20 nm, and a length of microns.

9. The head-mounted device defined in claim 8 wherein the multi-walled carbon nanotubes comprise non-functionalized multi-walled carbon nanotubes and wherein the coating is formed with a polyvinyl butyral dispersant.

10. An electronic device comprising:
a housing comprising a housing wall;
an optical component in the housing; and
a low-visible-reflectance-and-low-infrared-reflectance coating on the housing wall, wherein the low-visible-reflectance-and-low-infrared-reflectance coating is formed with an organic solvent having zero polarity.

11. The electronic device defined in claim 10 wherein the low-visible-reflectance-and-low-infrared-reflectance coating comprises multi-walled carbon nanotubes.

12. The electronic device defined in claim 11 wherein the multi-walled carbon nanotubes have a purity of at least 95%.

13. The electronic device defined in claim 11 wherein the organic solvent is heptane.

14. The electronic device defined in claim 13 wherein the housing wall comprises magnesium.

15. The electronic device defined in claim 14 wherein the low-visible-reflectance-and-low-infrared-reflectance has a thickness of 30 microns or less.

16. The electronic device defined in claim 10 wherein less than 1% of light across visible wavelengths is reflected by the low-visible-reflectance-and-low-infrared-reflectance coating and wherein less than 2% of light across infrared wavelengths is reflected by the low-visible-reflectance-and-low-infrared-reflectance coating.

17. The electronic device defined in claim 16 wherein the low-visible-reflectance-and-low-infrared-reflectance coating has less than 700 g/L in volatile organic content.

18. The electronic device defined in claim 10 wherein the housing wall comprises a material selected from the group consisting of: magnesium, aluminum, plastic, and stainless steel.

19. The electronic device defined in claim 10 further comprising a primer interposed between the housing wall and the low-visible-reflectance-and-low-infrared-reflectance coating.

20. An electronic device comprising:
a housing comprising a housing wall;
an optical component in the housing; and
a coating on the housing wall, wherein less than 1% of light across visible light wavelengths is reflected by the coating, less than 2% of light across infrared light wavelengths is reflected by the coating, and the coating has less than 700 g/L in volatile organic content.

21. The electronic device defined in claim 20 wherein the coating comprises an organic solvent having zero polarity.

22. The electronic device defined in claim 21 wherein the organic solvent is selected from the group consisting of: hexane, pentane, and heptane.
